(19) United States
(12) Patent Application Publication
(10) Pub. No.: US 2015/0132405 A1
(43) Pub. Date: May 14, 2015

(54) SYNERGISTIC COMPOSITIONS OF MONOCHLOROUREA AND MODIFIED MONOCHLOROUREAS

(71) Applicant: HERCULES INCORPORATED, Wilmington, DE (US)

(72) Inventor: John S Chapman, Lincoln University, PA (US)

(73) Assignee: HERCULES INCORPORATED, Wilmington, DE (US)

(21) Appl. No.: 14/212,804

(22) Filed: Mar. 14, 2014

Related U.S. Application Data
(60) Provisional application No. 61/791,625, filed on Mar. 15, 2013.

(51) Int. Cl. A01N 47/28; A01N 59/00; A01N 33/20; A01N 43/80; A01N 37/34; A01N 33/02; A01N 43/50

(52) U.S. Cl. CPC A01N 47/28; A01N 33/02; A01N 59/00; A01N 43/50; A01N 43/80; A01N 37/34; A01N 33/20
USPC 424/616; 514/588; 514/389; 514/373; 514/372; 514/515

(57) ABSTRACT

The present invention provides synergistic combinations of monochlorourea with other biocides for controlling microbial growth in aqueous systems. It also provides synergistic combinations of dimethyl monochlorourea with other biocides for controlling growth in aqueous systems. The synergistic combinations of monochlorourea and dimethyl monochlorourea with other biocides allows for the reduced use of total biocides to provide control of microbial growth in aqueous systems.

This application claims the benefit of U.S. provisional application No. 61/791625, filed Mar. 15, 2013, the entire contents of which are hereby incorporated by reference

### FIELD OF THE INVENTION

The invention relates to synergistic combinations of biocides and methods of their use for the control of microorganisms in aqueous and water containing systems.

### BACKGROUND OF THE INVENTION

Microbial contamination of aqueous systems is a serious problem which impacts systems performance, product quality, and human health. For instance, microbial contamination of cooling systems can cause a decrease in efficiency of the ability to cool water which leads to increased energy costs, a need for more intensive maintenance, and can develop into a harbor for pathogenic microbes such as Legionella. Contamination of aqueous systems such as fluids used in pulp and paper-making cause paper line breaks which result in cessations of operation, low paper quality, and contamination of paper products with microbial spores rendering them unfit for packaging food. The ubiquity of water in manufacturing, hydrocarbon extraction and processing, mining, food processing, agriculture, waste processing, and the overwhelming majority of human endeavors ensures that control of microbial contamination in all these activities will always be extremely important.

The predominant strategy for the control of microbes is treatment with biocides. Biocides are used to eliminate, reduce, or otherwise control the number of microbes in the aqueous systems. However, the use of biocides will always add cost to operations and products and thus more effective ways to achieve microbial control are sought. In addition, some biocides may have deficiencies in either their spectrum of antimicrobial action or operational limitations in their manner of application such as lack of temperature stability or susceptibility to inactivation by environmental or chemical factors. Thus combinations of biocides may be used, and in particular synergistic combinations of biocides are preferred. Synergistic combinations of biocides produce a greater degree of microbial control beyond the merely additive effects of each individual biocide.

Monochlorourea, methyl monochlorourea, and dimethyl chlorourea are fast-acting biocides which are very effective in aqueous systems.

Synergistic combinations of biocides can deliver an improved cost performance over those combinations which are merely additive in terms of antimicrobial efficacy.

### BRIEF SUMMARY OF THE INVENTION

The invention provides synergistic biocidal compositions. These compositions are useful for controlling microorganisms in water and aqueous systems. The compositions of the invention comprise monochlorourea in combination with at least one biocide selected from the group consisting of glutaraldehyde, quaternary ammonium compounds, dibromonitropropionamide, bromonitropropanediol, methylene bisthiocyanate, chloromethylisothiazolone, methylisothiazolone, benzisothiazolone, hydrogen peroxide, monochloramine, bromine-activated chlorine, methyl monochlorourea, dimethyl monochlorourea, tetrakis hydroxymethyl phosphonium sulfate, and bromochlorodimethylhydantoin. Another composition comprises dimethyl chlorourea in combination with at least one biocide selected from the group consisting of glutaraldehyde, quaternary ammonium compounds, dibromonitropropionamide, 2-bromo-2-nitropropane-1,3-diol, methylene bisthiocyanate, chloromethylisothiazolone/methylisothiazolone, methylisothiazolone, benzisothiazolone, hydrogen peroxide, monochloramine, bromine-activated chlorine, methyl monochlorourea, and bromochlorodimethylhydantoin.

Another aspect of the invention provides a method for controlling microbes in water or an aqueous systems. The method comprises treating the system with the biocidel compositions described above by adding to the aqueous system an effective amount of the synergistic combinations of the invention.

### DETAILED DESCRIPTION OF THE INVENTION

The invention provides synergistic biocidel combinations and methods of using them in the control of microorganisms. The synergistic biocidal combinations comprise monochlorourea with dimethyl monochlorourea, and monochlorourea or dimethyl monochlorourea with any one or more of the following: glutaraldehyde, quaternary ammonium compounds, 2,2-dibromo-3-nitrilopropionamide, 2-bromo-3-nitropropane-1,3-diol, methylene bisthiocyanate, 5-chloro-2-methylisothiazolone/2-methylisothiazolone (3;1 ratio), 2-methylisothiazolone, 1,2-benzisothiazolone, hydrogen peroxide, monochloramine, bromine-activated chlorine, methyl monochlorourea, and 1-bromo-3-chloro-5,5-dimethylhydantoin. Additional combinations comprise dimethyl monochlorourea with any one or more of the following: glutaraldehyde, quaternary ammonium compounds, 2,2-dibromo-3-nitrilopropionamide, 2-bromo-3-nitropropane-1,3-diol, methylene bisthiocyanate, 5-chloro-2-methylisothiazolone/2-methylisothiazolone (3;1 ratio), 2-methylisothiazolone, 1,2-benzisothiazolone, hydrogen peroxide, monochloramine, Spectrum™ XD3899 (“bromine-activated chloramine”) (Hercules Incorporated Wilmington, DE), methyl monochlorourea, and 1-bromo-3-chloro-5,5-dimethylhydantoin. It has been discovered that these combinations are synergistic in water or aqueous systems when used for microbial control. Thus, the combined biocidal materials result in improved antimicrobial efficacy beyond that which would be expected based on the sum of their individual antimicrobial efficacies. This unexpectedly observed synergy permits reduced amounts of the biocides to be used to achieve acceptable microbial control in water and aqueous systems, potentially resulting in enhanced performance, reduced environmental impact, and reduced impact to downstream wastewater treatment systems.

The invention provides for a microbicidal composition comprising: a first biocide and at least one second biocide
wherein the first biocide is selected from the group consisting of monochlorourea and modified monochlorourea; and
wherein the second biocide is selected from the group consisting of methyl monochlorourea, dimethyl monochlorourea, bromine activated monochloramine, monochloramine, hydrogen peroxide, 1-bromo-3-chloro-5,5-dimethylhydantoin, benzisothiazolone, 2-methylisothiazolone, tetrakis (hydroxymethyl) phosphonium sulfate, methylene bisthiocyanate, 2-bromo-2-nitropropane-1,3,-diol, 2,2-dibromo-3-nitrilopropionamide, N-alkyl (C₁₂-C₁₆)-N,N-dimethyl benzylalkonium chloride, the combination biocide 2-methyl-5-chloro-isothiazolin-3-one/2-methyl-isothazolin-3-one, and glutaraldehyde; with the proviso that the first biocide is different (not the same biocide) from the second biocide.

A method of treating an aqueous system, the method comprising adding an effective amount of a first biocide and at least one second biocide to an aqueous system, wherein the first biocide is selected from the group consisting of monochlorourea and modified monochlorourea; and
wherein the second biocide is selected from the group consisting of methyl monochlorourea, dimethyl monochlorourea, bromine activated monochloramine, monochloramine, hydrogen peroxide, 1-bromo-3-chloro-5,5-dimethylhydantoin, benzisothiazolone, 2-methylisothiazolone, tetrakis (hydroxymethyl) phosphonium sulfate, methylene bisthiocyanate, 2-bromo-2-nitropropane-1,3,-diol, 2,2-dibromo-3-nitrilopropionamide, N-alkyl (C₁₂-C₁₆)-N,N-dimethyl benzylalkonium chloride, the combination biocide 2-methyl-5-chloro-isothiazolin-3-one/2-methyl-isothazolin-3-one, and glutaraldehyde; with the proviso that the first biocide is different (not the same biocide) from the second biocide.

For the purposes of this specification, the meaning of “microorganisms” and “microbes” includes, but is not limited to, bacteria, fungi, algae, protozoans, and viruses. Preferred microbes against which these compositions are effective are bacteria. It is also understood that the microbes within water or aqueous systems can be located suspended within the fluid (eg., planktonic) or localized on a surface in contact with the aqueous system (eg., biofilms). The words and phrases “control”, “microbial control”, “controlling”, and “antimicrobial efficacy” should be broadly construed to include within their meaning, without being limited to, inhibiting the growth of microbes, killing microbes, disinfection, preservation, sanitization, or preventing the re-growth of microbes.

As used herein ppm is measured as mass per volume or 1 ppm equals 1 mg (active) per liter

Monochlorourea and modified monochlorourea compounds may include, but are not limited to, monochlorourea, N-methyl-monochlorourea, N′-methyl-N-monochlorourea, N,N-dimethyl-N′-monochlorourea, N,N′-dimethyl-N-monochlorourea, N-ethyl-N-monochlorourea, N′-ethyl-N-monochlorourea, N,N-diethyl-N′-monochlorourea, N,N′-diethyl-N-monochlorourea.

Examples of water and aqueous systems in which the compositions are useful are cooling water, boiler water, pulp and paper mill water, oil and gas field injection water and produced water, oil and gas pipelines and storage systems, fuel, ballast water, wastewater, pasteurizers, other industrial process water, metalworking fluids, latex, polymers, paint, coatings, adhesives, inks, personal care and household products, reverse osmosis systems, electrochemical deposition systems, fluids used in mineral extraction, mineral slurries, agricultural processing, biorefining waters, and systems that use them. In addition, the compositions may be used in other areas where microbial contamination of water and aqueous systems is required. Preferred aqueous systems are cooling water, boiler water, pulp and paper processes.

The monochlorourea or modified monochlorourea is used in amounts of from 0.1 ppm to 100 ppm in the system being treated or from 0.1 to 50 ppm or from 0.1 to 25 ppm or from 0.5 to 15 ppm.

Generally the concentration of the second biocide used is less than 150 ppm or less than 100 ppm or less than 75 ppm or less than 50 ppm in the system being treated. Concentrations of hydrogen peroxide used are generally greater than other biocides and can be as much as 2500 ppm or more

In some embodimentsthe ratio of monochlorourea or modified monochlorourea to second biocide can be from 1:100 to 800:1, or from 1:50 to 400:1, or from 1: 20 to 200:1.

In some embodiments the ratio of dimethyl monochlorourea to second biocide can be from 1 :700 to 700:1, or from 1:500 to 50 :1, or from 0.05:1 to 400:1 or from 1:250 to 75:1.

A person of ordinary skill in the art using the description of the invention can readily determine the concentration of the composition required to achieve acceptable microbial control.

The components of the composition can be added to the water or aqueous system separately or blended prior to addition. A person of ordinary skill in the art can readily determine the appropriate method of addition. The composition can be added to the water or aqueous system with other additives such as, but not limited to, surfactants, scale and corrosion control compounds, ionic or non-ionic polymers, pH control agents, and other additives used for altering or modifying the chemistry of the water or aqueous system. In addition, the compositions may be used in water and aqueous systems which contain other biocidal agents.

### EXAMPLES

The synergy indices reported in the following examples use the following formula: Synergy Index=Qa/QA+Qb/QB
where Qa is the concentration of Biocide A required to achieve complete inhibition of growth of the test microbe when used in combination with Biocide B;
QA is the concentration of Biocide A required to achieve complete inhibition of growth of the test microbe when used alone;
Qb is the concentration of Biocide B required to achieve complete inhibition of growth of the test microbe when used in combination with Biocide A;
QB is the concentration of Biocide B required to achieve complete inhibition of growth of the test microbe when used alone.

In the examples the QA, QB, Qa, Qb are measured in ppm.

A synergy index (SI) of 1 indicates the interactions between the two biocides is merely additive, a SI of greater than one indicates the two biocides are antagonistic with each other, and a SI of less than 1 indicates the two biocides interact in a synergistic manner.

While there are various methods known to individuals skilled in the art for measuring levels of antimicrobial activity, in the following examples the endpoint used is known as the Minimal Inhibitory Concentration, or MIC. This is the lowest concentration of a substance or substances which can achieve complete inhibition of growth.

In order to determine the Minimal Inhibitory Concentration, a two-fold dilution series of the biocide is constructed with the dilutions being made in growth media. The dilutions are made in a 96 well microplate such that each well has a final volume of 280 μl of media and biocide. The first well has, for example, a concentration of 1000 ppm biocide, the second 500 ppm, the third 250 ppm, and so forth, with the 12^{th} and final well in the row having no biocide at all and serving as a positive growth control. After the dilution series is constructed the wells receive an inoculum of microbe suspended in growth media such that the final concentration of microbes in the well is ˜5×10⁵ cfu/ml. In these examples the test microbe used is Escherichia coli. The cultures are incubated at an appropriate temperature for 18-24 hours, and the wells scored as positive or negative for growth based on a visual examination for turbid wells. The lowest concentration of biocide which completely inhibits growth (eg., a clear well) is designated the Minimal Inhibitory Concentration.

In order to determine whether the interaction between two biocides is additive, antagonistic, or synergistic against a target microbe a modification of the MIC method known as the “checkerboard” method is employed using 96 well microplates. To construct a checkerboard plate the first biocide is deployed using the two-fold serial dilution method used to construct an MIC plate, except that each of the eight rows is an identical dilution series which terminates after the eighth column. The second biocide is deployed by adding identical volumes of a twofold dilution series at right angles to the first series. The result is each well of the 8×8 well square has a different combination of biocide concentrations, yielding 64 different combinations in total. The 9^{th} and 10^{th} columns receive no biocide at all and serve as positive and negative growth controls, respectively. After the checkerboard microplate is constructed, it is inoculated with Escherichia coli, incubated at 37° C., and scored as described for the MIC method.

### Example 1

### Synergy of MCU with Methyl Monochlorourea

Minimal inhibitory concentrations were determined for both monochlorourea and methyl monochlorourea (abbreviated MMCU in Table 1) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate MCU is broadly synergistic with methyl monochlorourea from concentration ratios of MCU to methyl monochlorourea from 1:10 to 128:1.

TABLE 1

| Used alone | | Used in Combination | | | |
|---|---|---|---|---|---|
| MCU | | MCU | MMCU | | |
| MIC | MMCU | MIC | MIC | MCU/MMCU | Synergy |
| (QA) | (QB) | (Qa) | (Qb) | Ratio | Index |
| 100 | 16 | 1.6 | 50 | 0.03 | 3.14 |
| 100 | 16 | 1.6 | 25 | 0.06 | 1.58 |
| 100 | 16 | 1.6 | 12.5 | 0.1 | 0.80 |
| 100 | 16 | 6.25 | 6.25 | 1 | 0.45 |
| 100 | 16 | 25 | 3.125 | 8 | 0.45 |
| 100 | 16 | 50 | 1.563 | 32 | 0.60 |
| 100 | 16 | 50 | 0.781 | 64 | 0.55 |
| 100 | 16 | 50 | 0.391 | 128 | 0.52 |

### Example 2

### Synergy of MCU with Dimethyl Monochlorourea

Minimal inhibitory concentrations were determined for both monochlorourea and methyl monochlorourea (abbreviated DMCU in Table 2) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate MCU is broadly synergistic with dimethyl monochlorourea from concentration ratios of MCU to dimethyl monochlorourea from 510:1 to 0.6:1.

TABLE 2

| Used alone | | Used in Combination | | | |
|---|---|---|---|---|---|
| MCU | | MCU | DMCU | | |
| MIC | DMCU | MIC | MIC | MCU/DMCU | Synergy |
| (QA) | (QB) | (Qa) | (Qb) | Ratio | Index |
| 100 | 10 | 100.00 | 0.10 | 1020 | 1.01 |
| 100 | 10 | 50.00 | 0.10 | 510 | 0.51 |
| 100 | 10 | 50.00 | 0.20 | 256 | 0.52 |
| 100 | 10 | 50.00 | 3.13 | 16 | 0.81 |
| 100 | 10 | 25.00 | 3.13 | 8 | 0.56 |
| 100 | 10 | 25.00 | 6.25 | 4 | 0.88 |
| 100 | 10 | 12.50 | 6.25 | 2 | 0.75 |
| 100 | 10 | 6.25 | 6.25 | 1 | 0.69 |
| 100 | 10 | 6.25 | 10.00 | 0.6 | 1.06 |

### Example 3

### Synergy of MCU with Spectrum™ XD3899 (Bromine Activated Monochloramine)

Minimal inhibitory concentrations were determined for both monochlorourea and Spectrum™ XD3899 (designated BAC in Table 3) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate MCU is broadly synergistic with BAC from concentration ratios of MCU to Spectrum™ 3899 from 12.5:1 to 400:1.

TABLE 3

| | |
|---|---|
| Used alone | Used in Combination |

| MCU | | MCU | BAC | | |
|---|---|---|---|---|---|
| MIC | BAC | MIC | MIC | MCU/BAC | Synergy |
| (QA) | (QB) | (Qa) | (Qb) | Ratio | Index |
| 100 | 4 | 1.6 | 16 | 0.1 | 4.02 |
| 100 | 4 | 1.6 | 8 | 0.2 | 2.02 |
| 100 | 4 | 1.6 | 4 | 0.4 | 1.02 |
| 100 | 4 | 25 | 2 | 12.5 | 0.75 |
| 100 | 4 | 50 | 1 | 50 | 0.75 |
| 100 | 4 | 50 | 0.5 | 100 | 0.63 |
| 100 | 4 | 50 | 0.25 | 200 | 0.56 |
| 100 | 4 | 50 | 0.125 | 400 | 0.53 |

### Example 4

### Synergy of MCU with Monochloramine

Minimal inhibitory concentrations were determined for both monochlorourea and monochloramine (abbreviated MCA in Table 4) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate MCU is broadly synergistic with monochloramine from concentration ratios of MCU to monochloramine from 1:10 to 128:1.

TABLE 4

| | |
|---|---|
| Used alone | Used in Combination |

| MCU | | MCU | MCA | | |
|---|---|---|---|---|---|
| MIC | MCA | MIC | MIC | MCU/MCA | Synergy |
| (QA) | (QB) | (Qa) | (Qb) | Ratio | Index |
| 100 | 47 | 1.6 | 50 | 0.03 | 1.08 |
| 100 | 47 | 1.6 | 25 | 0.1 | 0.55 |
| 100 | 47 | 12.5 | 12.5 | 1.0 | 0.39 |
| 100 | 47 | 50 | 6.3 | 8 | 0.63 |
| 100 | 47 | 50 | 3.1 | 16 | 0.57 |
| 100 | 47 | 50 | 1.6 | 32 | 0.53 |
| 100 | 47 | 50 | 0.8 | 64 | 0.52 |
| 100 | 47 | 50 | 0.4 | 128 | 0.51 |

### Example 5

### Synergy of MCU with Hydrogen Peroxide

Minimal inhibitory concentrations were determined for both monochlorourea and hydrogen peroxide (abbreviated H202 in Table 5) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate MCU is broadly synergistic with hydrogen peroxide from concentration ratios of MCU to hydrogen peroxide from 1:10 to 3.2:1.

TABLE 5

| Used alone | | Used in Combination | | | |
|---|---|---|---|---|---|
| MCU | | MCU | H2O2 | | |
| MIC | H2O2 | MIC | MIC | MCU/H2O2 | Synergy |
| (QA) | (QB) | (Qa) | (Qb) | Ratio | Index |
| 100 | 1000 | 1.6 | 2000 | 0.001 | 2.02 |
| 100 | 1000 | 1.6 | 1000 | 0.002 | 1.02 |
| 100 | 1000 | 25 | 500 | 0.1 | 0.75 |
| 100 | 1000 | 50 | 250 | 0.2 | 0.75 |
| 100 | 1000 | 50 | 125 | 0.4 | 0.63 |
| 100 | 1000 | 50 | 62.5 | 0.8 | 0.56 |
| 100 | 1000 | 50 | 31.25 | 1.6 | 0.53 |
| 100 | 1000 | 50 | 15.625 | 3.2 | 0.52 |

### Example 6

### Synergy of MCU with 1-bromo-3-chloro-5,5-dimethylhydantoin

Minimal inhibitory concentrations were determined for both monochiorourea and 1-bromo-3-chloro-5,5-dimethylhydantoin (abbreviated BCDMH in Table 6) using the protocol described above with Escherichia coli as the test microbe. Using twice the concentration of the MIC expressed as parts per million as the highest concentration, checkerboard synergy plates were constructed as described, the wells inoculated to a final concentration of -5×10⁵ cfu/ml, incubated for 18-24 hours, and then scored visually for growth/no growth. The experiment was repeated 3 times and the results summarized below. Synergy indices were calculated according to the formula. The results indicate MCU is broadly synergistic with 1-brorno-3-chloro-5,5-dimethyhydantoin from concentration ratios of MCU to 1-bromo-3-chloro-5,5-dimethylhydantoin from 1:10 to 50:1.

TABLE 6

| Used alone | | Used in Combination | | | |
|---|---|---|---|---|---|
| MCU | | MCU | BCDMH | | |
| MIC | BCDMH | MIC | MIC | MCU/BCDMH | Synergy |
| (QA) | (QB) | (Qa) | (Qb) | Ratio | Index |
| 100 | 61 | 1.6 | 125 | 0.01 | 2.06 |
| 100 | 61 | 1.6 | 62.5 | 0.03 | 1.04 |
| 100 | 61 | 1.6 | 31.25 | 0.1 | 0.53 |
| 100 | 61 | 25 | 15.6 | 1.6 | 0.51 |
| 100 | 61 | 50 | 7.8 | 6.4 | 0.63 |
| 100 | 61 | 50 | 3.9 | 13.0 | 0.56 |
| 100 | 61 | 50 | 2.0 | 25 | 0.53 |
| 100 | 61 | 50 | 1.0 | 50 | 0.52 |

### Example 7

### Synergy of MCU with Benzisothiazolone

Minimal inhibitory concentrations were determined for both monochiorourea and benzisothiazolone (abbreviated BIT in Table 7) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula3. The results indicate MCU is broadly synergistic with benzisothiazolone from concentration ratios of MCU to benzisothiazolone from 0.4:1 to 100:1.

TABLE 7

| | |
|---|---|
| Used alone | Used in Combination |

| MCU | | MCU | BIT | | |
|---|---|---|---|---|---|
| MIC | BIT | MIC | MIC | MCU/BIT | Synergy |
| (QA) | (QB) | (Qa) | (Qb) | Ratio | Index |
| 100 | 57 | 1.6 | 64 | 0.02 | 1.14 |
| 100 | 57 | 12.5 | 32 | 0.4 | 0.69 |
| 100 | 57 | 50 | 16 | 3.1 | 0.78 |
| 100 | 57 | 50 | 8 | 6.3 | 0.64 |
| 100 | 57 | 50 | 4 | 12.5 | 0.57 |
| 100 | 57 | 50 | 2 | 25 | 0.54 |
| 100 | 57 | 50 | 1 | 50 | 0.52 |
| 100 | 57 | 50 | 0.5 | 100 | 0.51 |

### Example 8

### Synergy of MCU with 2-Methyl Isothiazolone

Minimal inhibitory concentrations were determined for both monochlorourea and 2-methyl isothiazolone (abbreviated MIT in Table 8) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula . The results indicate MCU is broadly synergistic with 2-methyl isothiazolone from concentration ratios of MCU to 2-methyl isothiazolone from 1:100 to 26:1.

TABLE 8

| | |
|---|---|
| Used alone | Used in Combination |

| MCU | | MCU | MIT | | |
|---|---|---|---|---|---|
| MIC | MIT | MIC | MIC | MCU/MIT | Synergy |
| (QA) | (QB) | (Qa) | (Qb) | Ratio | Index |
| 100 | 180 | 1.6 | 250 | 0.006 | 1.40 |
| 100 | 180 | 1.6 | 125 | 0.01 | 0.71 |
| 100 | 180 | 12.5 | 62.5 | 0.2 | 0.47 |
| 100 | 180 | 25 | 31.25 | 0.8 | 0.42 |
| 100 | 180 | 50 | 16 | 3.2 | 0.59 |
| 100 | 180 | 50 | 8 | 6.4 | 0.54 |
| 100 | 180 | 50 | 4 | 12.5 | 0.52 |
| 100 | 180 | 50 | 2 | 25 | 0.51 |

### Example 9

### Synergy of MCU with methylene bisthiocyanate

Minimal inhibitory concentrations were determined for both monochlorourea and methylene bisthiocyanate (abbreviated MBT in Table 9) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate MCU is broadly synergistic with methylene bisthiocyanate from concentration ratios of MCU to methylene bisthiocyanate from 0.4:1 to 400:1.

TABLE 9

| | |
|---|---|
| Used alone | Used in Combination |

| MCU | | MCU | MBT | | |
|---|---|---|---|---|---|
| MIC | MBT | MIC | MIC | MCU/MBT | Synergy |
| (QA) | (QB) | (Qa) | (Qb) | Ratio | Index |
| 100 | 8 | 1.6 | 16 | 0.1 | 2.02 |
| 100 | 8 | 1.6 | 8 | 0.2 | 1.02 |
| 100 | 8 | 1.563 | 4 | 0.4 | 0.52 |
| 100 | 8 | 25 | 2 | 12.5 | 0.50 |
| 100 | 8 | 50 | 1 | 50 | 0.63 |
| 100 | 8 | 50 | 0.5 | 100 | 0.56 |
| 100 | 8 | 50 | 0.25 | 200 | 0.53 |
| 100 | 8 | 50 | 0.125 | 400 | 0.52 |

### Example 10

### Synergy of MCU with 2-bromo-2-nitropropane-1,3,-diol

Minimal inhibitory concentrations were determined for both monochlorourea and 2-bromo-2-nitropropane-1,3,-diol (abbreviated BNPD in Table 10) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate MCU is broadly synergistic with 2-bromo-2-nitropropane-1,3,-diol from concentration ratios of MCU to 2-bromo-2-nitropropane-1,3,-diol from 1.6:1 to 100:1.

TABLE 10

| Used alone | | Used in Combination | | | |
|---|---|---|---|---|---|
| MCU | | MCU | DBNPA | | |
| MIC | BNPD | MIC | MIC | MCU/DBNPA | Synergy |
| (QA) | (QB) | (Qa) | (Qb) | Ratio | Index |
| 100 | 24 | 1.6 | 64 | 0.02 | 2.68 |
| 100 | 24 | 1.6 | 32 | 0.05 | 1.35 |
| 100 | 24 | 25 | 16 | 1.6 | 0.92 |
| 100 | 24 | 50 | 8 | 6.3 | 0.83 |
| 100 | 24 | 50 | 4 | 12.5 | 0.67 |
| 100 | 24 | 50 | 2 | 25 | 0.58 |
| 100 | 24 | 50 | 1 | 50 | 0.54 |
| 100 | 24 | 50 | 0.5 | 100 | 0.52 |

### Example 11

### Synergy of MCU with 2,2-dibromo-3-nitrilopropionamide

Minimal inhibitory concentrations were determined for both monochlorourea and 2,2-dibromo-3-nitrilopropionamide (abbreviated DBNPA in Table 11 using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 5 times and the results summarized below. Synergy indices were calculated according to the formula . The results indicate MCU is broadly synergistic with 2,2-dibromo-3-nitrilopropionamide from concentration ratios of MCU to 2,2-dibromo-3-nitrilopropionamide from 0.8:1 to 794:1.

TABLE 11

| Used alone | | Used in Combination | | | |
|---|---|---|---|---|---|
| MCU | | MCU | DBNPA | | |
| MIC | DBNPA | MIC | MIC | MCU/DBNPA | Synergy |
| (QA) | (QB) | (Qa) | (Qb) | Ratio | Index |
| 100 | 11 | 6.25 | 8 | 0.8 | 0.79 |
| 100 | 11 | 25 | 4 | 6.3 | 0.61 |
| 100 | 11 | 25 | 2 | 12.5 | 0.43 |
| 100 | 11 | 50 | 1 | 50.0 | 0.59 |
| 100 | 11 | 50 | 0.5 | 100 | 0.55 |
| 100 | 11 | 50 | 0.25 | 200 | 0.52 |
| 100 | 11 | 50 | 0.125 | 400 | 0.51 |
| 100 | 11 | 50 | 0.063 | 794 | 0.51 |

### Example 12

### Synergy of MCU with N-alkyl (C₁₂-C₁₆)-N,N-dimethyl benzylalkonium Chloride

Minimal inhibitory concentrations were determined for both monochlorourea and N-alkyl (C₁₂-C₁₆)-N,N-dimethyl benzylalkonium chloride (abbreviated QAC in Table 12) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 5 times and the results summarized below. Synergy indices were calculated according to the formula . The results indicate MCU is broadly synergistic with N-alkyl (C₁₂-C₁₆)-N,N-dimothyl benzylalkonium chloride from concentration ratios of MCU to N-alkyl (C₁₂-C₁₆)-N,N-dimethyl benzylalkonium chloride from 1:2.5 to 200:1.

TABLE 12

| | |
|---|---|
| Used alone | Used in Combination |

| MCU | | MCU | QAC | | |
|---|---|---|---|---|---|
| MIC | QAC | MIC | MIC | MCU/QAC | Synergy |
| (QA) | (QB) | (Qa) | (Qb) | Ratio | Index |
| 100 | 27 | 1.6 | 32 | 0.05 | 1.20 |
| 100 | 27 | 6.25 | 16 | 0.4 | 0.66 |
| 100 | 27 | 25 | 8 | 3.1 | 0.55 |
| 100 | 27 | 50 | 4 | 12.5 | 0.65 |
| 100 | 27 | 50 | 2 | 25 | 0.57 |
| 100 | 27 | 50 | 1 | 50 | 0.54 |
| 100 | 27 | 50 | 0.5 | 100 | 0.52 |
| 100 | 27 | 50 | 0.25 | 200 | 0.51 |

### Example 13

### Synergy of MCU with the Combination Biocide 2-methyl-5-chloro-isothiazolin-3-one/2-methyl-isothazolin-3-one

Minimal inhibitory concentrations were determined for both monochlorourea and the CMIT/MIT combination biocide using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 5 times and the results summarized below. Synergy indices were calculated according to the formula. The results indicate MCU is broadly synergistic with the CMIT/MIT combination biocide from concentration ratios of MCU to the CMIT/MIT combination biocide from 1.6:1 to 3125:1.

TABLE 13

| Used alone | | Used in Combination | | | |
|---|---|---|---|---|---|
| MCU | | MCU | | | |
| MIC | CMIT/MIT | MIC | CMIT/MIT | MCU/(CMIT/MIT) | Synergy |
| (QA) | MIC (QB) | (Qa) | MIC (Qb) | Ratio | Index |
| 100 | 2 | 1.6 | 1 | 1.6 | 0.52 |
| 100 | 2 | 50 | 0.5 | 100 | 0.75 |
| 100 | 2 | 50 | 0.25 | 200 | 0.63 |
| 100 | 2 | 50 | 0.125 | 400 | 0.56 |
| 100 | 2 | 50 | 0.063 | 794 | 0.53 |
| 100 | 2 | 50 | 0.031 | 1613 | 0.52 |
| 100 | 2 | 50 | 0.016 | 3125 | 0.51 |

### Example 14

### Synergy of MCU with Glutaraldehyde

Minimal inhibitory concentrations were determined for both monochlorourea and glutaraldehyde (abbreviated GLUT in Table 14 below) using the protocol described above with Escherichia coli as the test microbe. Using twice the concentration of the MIC expressed as parts per million, as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 5 times and the results summarized below. Synergy indices were calculated according to the formula. The results indicate MCU is broadly synergistic with glutaraldehyde from concentration ratios of MCU to glutaraldehyde from 3.1:1 to 100:1.

TABLE 14

| Used alone | | Used in Combination | | | |
|---|---|---|---|---|---|
| MCU | | MCU | | | |
| MIC | GLUT | MIC | GLUT | MCU/GLUT | Synergy |
| (QA) | (QB) | (Qa) | MIC (Qb) | Ratio | Index |
| 100 | 45 | 50 | 32 | 1.6 | 1.21 |
| 100 | 45 | 50 | 16 | 3.1 | 0.86 |
| 100 | 45 | 50 | 8 | 6.3 | 0.68 |
| 100 | 45 | 50 | 4 | 12.5 | 0.59 |
| 100 | 45 | 50 | 2 | 25 | 0.54 |
| 100 | 45 | 50 | 1 | 50 | 0.52 |
| 100 | 45 | 50 | 0.5 | 100 | 0.51 |
| 100 | 45 | 25 | 0.25 | 100 | 0.26 |

### Example 15

### Synergy of DMCU with Monochlorourea

Minimal inhibitory concentrations were determined for both dimethyl chlorourea and monochlorourea (abbreviated MCU in Table 15) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with monochlorourea from concentration ratios of DMCU to monochlorourea from 1:512 to 1:1.

TABLE 15

| Used alone | | Used in Combination | | | |
|---|---|---|---|---|---|
| DMCU | | DMCU | | | |
| MIC | MCU MIC | MIC | MCU MIC | DMCU/MCU | Synergy |
| (QA) | QB | (Qa) | QB | Ratio | Index |
| 10 | 100 | 0.10 | 100.00 | 1/1024 | 1.01 |
| 10 | 100 | 0.10 | 50.00 | 1/512 | 0.51 |
| 10 | 100 | 0.20 | 50.00 | 1/256 | 0.52 |
| 10 | 100 | 3.13 | 50.00 | 1/16 | 0.81 |
| 10 | 100 | 3.13 | 25.00 | 1/8 | 0.56 |
| 10 | 100 | 6.25 | 25.00 | 1/4 | 0.88 |
| 10 | 100 | 6.25 | 12.50 | 1/2 | 0.75 |
| 10 | 100 | 6.25 | 6.25 | 1 | 0.69 |
| 10 | 100 | 10.00 | 6.25 | 3/2 | 1.06 |

### Example 16

### Synergy of DMCU with Methyl Monochlorourea

Minimal inhibitory concentrations were determined for both dimethyl chlorourea and methyl monochlorourea (abbreviated MMCU in Table 16) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with methyl monochlorourea from concentration ratios of DMCU to methyl monochlorourea from 1:125 to 8:1.

TABLE 16

| Used alone | | Used in Combination | | | |
|---|---|---|---|---|---|
| DMCU | | DMCU | | | |
| MIC | MMCU | MIC | MMCU | DMCU/MMCU | Synergy |
| (QA) | MIC (QB) | (Qa) | MIC (Qb) | Ratio | Index |
| 10 | 16 | 0.10 | 25.00 | 1/250 | 1.57 |
| 10 | 16 | 0.10 | 12.50 | 1/125 | 0.79 |
| 10 | 16 | 3.13 | 6.25 | 1/2 | 0.70 |
| 10 | 16 | 6.25 | 3.13 | 2 | 0.82 |
| 10 | 16 | 10.00 | 1.60 | 6 | 1.10 |
| 10 | 16 | 6.25 | 0.80 | 8 | 0.67 |
| 10 | 16 | 10.00 | 0.80 | 25/2 | 1.05 |

### Example 17

### Synergy of DMCU with Spectrum™ XD3899

Minimal inhibitory concentrations were determined for both dimethyl chlorourea and Spectrum™ XD3899 (“bromine-activated chlorine”, abbreviated BAC in Table 17) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with BAC from concentration ratios of DMCU to BAC from 1:20 to 25:4.

TABLE 17

| Used alone | | Used in Combination | | | |
|---|---|---|---|---|---|
| DMCU | | DMCU | | | |
| MIC | BAC MIC | MIC | BAC MIC | | Synergy |
| (QA) | (QB) | (Qa) | (Qb) | DMCU/BAC Ratio | Index |
| 10 | 4 | 0.10 | 4 | 1/40 | 1.01 |
| 10 | 4 | 0.10 | 2 | 1/20 | 0.51 |
| 10 | 4 | 0.80 | 4 | 1/5 | 1.08 |
| 10 | 4 | 0.40 | 1 | 2/5 | 0.29 |
| 10 | 4 | 0.80 | 2 | 2/5 | 0.58 |
| 10 | 4 | 1.56 | 1 | 3/2 | 0.71 |
| 10 | 4 | 6.25 | 2 | 3 | 0.82 |
| 10 | 4 | 3.13 | 0.5 | 25/4 | 0.44 |
| 10 | 4 | 6.25 | 1 | 25/4 | 0.54 |
| 10 | 4 | 12.50 | 1 | 25/2 | 1.15 |
| 10 | 4 | 12.50 | 0.5 | 25 | 1.23 |
| 10 | 4 | 12.50 | 0.25 | 50 | 1.01 |
| 10 | 4 | 12.50 | 0.125 | 100 | 1.15 |

### Example 18

### Synergy of DMCU with Monochloramine

Minimal inhibitory concentrations were determined for both dimethyl chlorourea and rnonochloramine (abbreviated MCA in Table 18) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with monochloramine from concentration ratios of DMCU to monochloramine from 1:250 to 1:4.

TABLE 18

| Used alone | | Used in Combination | | | |
|---|---|---|---|---|---|
| DMCU | | DMCU | | | |
| MIC | MCA MIC | MIC | MCA MIC | DMCU/MCA | Synergy |
| (QA) | (QB) | (Qa) | (Qb) | Ratio | Index |
| 10 | 47 | 0.10 | 50 | 1/500 | 1.07 |
| 10 | 47 | 0.10 | 25 | 1/250 | 0.54 |
| 10 | 47 | 0.80 | 25 | 1/62 | 0.61 |
| 10 | 47 | 0.80 | 25 | 1/31 | 0.61 |
| 10 | 47 | 3.13 | 12.5 | 1/4 | 0.75 |
| 10 | 47 | 10.00 | 12.5 | 4/5 | 1.27 |

### Example 19

### Synergy of DMCU with Hydrogen Peroxide

Minimal inhibitory concentrations were determined for both dimethyl chlorourea and hydrogen peroxide (abbreviated H202 in Table 19) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with hydrogen peroxide from concentration ratios of DMCU to hydrogen peroxide from 1:640 to 2:5.

TABLE 19

| Used alone | | Used in Combination | | | |
|---|---|---|---|---|---|
| DMCU | | DMCU | | | |
| MIC | H2O2 | MIC | H2O2 | DMCU/H2O2 | Synergy |
| (QA) | MIC (QB) | (Qa) | MIC (Qb) | Ratio | Index |
| 10 | 1000 | 0.78 | 500 | 1/640 | 0.58 |
| 10 | 1000 | 1.56 | 500 | 1/320 | 0.66 |
| 10 | 1000 | 1.56 | 125 | 1/80 | 0.28 |
| 10 | 1000 | 6.25 | 250 | 1/40 | 0.66 |
| 10 | 1000 | 6.25 | 125 | 1/20 | 0.56 |
| 10 | 1000 | 6.25 | 63 | 1/10 | 0.52 |
| 10 | 1000 | 1.56 | 8 | 1/5 | 0.16 |
| 10 | 1000 | 6.25 | 16 | 2/5 | 0.64 |

### Example 20

### Synergy of DMCU with 1-bromo-3-chloro-5,5-dimethylhydantoin

Minimal inhibitory concentrations were determined for both dimethyl chlorourea and 1-bromo-3-chloro-5,5-dimethylhydantoin (abbreviated BCDMH in Table 20) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with 1-bromo-3-chloro-5,5-dimethylhydantoin from concentration ratios of DMCU to 1-brorno-3-chloro-5,5-dimethylhydantoin from 1:40 to 3:1.

TABLE 20

| Used alone | | Used in Combination | | | |
|---|---|---|---|---|---|
| DMCU | | DMCU | | | |
| MIC | BCDMH | MIC | BCDMH | DMCU/BCDMH | Synergy |
| (QA) | MIC (QB) | (Qa) | MIC (Qb) | Ratio | Index |
| 10 | 61 | 0.1 | 62.50 | 1/625 | 1.03 |
| 10 | 61 | 0.8 | 62.50 | 1/80 | 1.10 |
| 10 | 61 | 0.8 | 32.00 | 1/40 | 0.59 |
| 10 | 61 | 3.125 | 16.00 | 1/5 | 0.57 |
| 10 | 61 | 6.25 | 16.00 | 2/5 | 0.88 |
| 10 | 61 | 6.25 | 8.00 | 4/5 | 0.75 |
| 10 | 61 | 6.25 | 4.00 | 3/2 | 0.69 |
| 10 | 61 | 6.25 | 2.00 | 3 | 0.66 |
| 10 | 61 | 12.5 | 2.00 | 6 | 1.10 |
| 10 | 61 | 12.5 | 1.00 | 12.5 | 1.27 |

### Example 21

### Synergy of DMCU with Benzisothiazolone

Minimal inhibitory concentrations were determined for both dimethyl chlorourea and benzisothiazolone (abbreviated BIT in Table 21) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with benzisothiazolone from concentration ratios of DMCU to benzisothiazolone from 1:160 to 25:2.

TABLE 21

| Used alone | | Used in Combination | | | |
|---|---|---|---|---|---|
| DMCU | | DMCU | | | |
| MIC | BIT MIC | MIC | BIT MIC | | Synergy |
| (QA) | (QB) | (Qa) | (Qb) | DMCU/BIT Ratio | Index |
| 10 | 57 | 0.10 | 64 | 1/640 | 1.13 |
| 10 | 57 | 0.20 | 32 | 1/160 | 0.58 |
| 10 | 57 | 0.92 | 32 | 1/35 | 0.65 |
| 10 | 57 | 6.25 | 32 | 1/5 | 1.19 |
| 10 | 57 | 3.13 | 16 | 1/5 | 0.59 |
| 10 | 57 | 6.25 | 16 | 25/64 | 0.91 |
| 10 | 57 | 6.25 | 8 | 25/32 | 0.77 |
| 10 | 57 | 6.25 | 4 | 3/2 | 0.70 |
| 10 | 57 | 6.25 | 2 | 3 | 0.66 |
| 10 | 57 | 6.25 | 1 | 6 | 0.64 |
| 10 | 57 | 6.25 | 0.5 | 25/2 | 0.63 |
| 10 | 57 | 10.00 | 0.5 | 20 | 1.01 |

### Example 22

### Synergy of DMCU with 2-Methyl lsothiazolone

Minimal inhibitory concentrations were determined for both dimethyl chlorourea and 2-methyl isothiazolone (abbreviated MIT in Table 22) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with 2-methyl isothiazolone from concentration ratios of DMCU to 2-methyl isothiazolone from 1:625 to 32:5.

TABLE 22

| Used alone | | Used in Combination | | | |
|---|---|---|---|---|---|
| DMCU | | DMCU | | | |
| MIC | MIT MIC | MIC | MIT MIC | | Synergy |
| (QA) | (QB) | (Qa) | (Qb) | DMCU/MIT Ratio | Index |
| 10 | 180 | 0.20 | 125.00 | 1/625 | 0.71 |
| 10 | 180 | 3.13 | 62.50 | 1/20 | 0.66 |
| 10 | 180 | 6.25 | 62.50 | 1/10 | 0.97 |
| 10 | 180 | 6.25 | 31.25 | 1/5 | 0.80 |
| 10 | 180 | 6.25 | 15.63 | 2/5 | 0.71 |
| 10 | 180 | 6.25 | 7.81 | 4/5 | 0.78 |
| 10 | 180 | 6.25 | 3.91 | 8/5 | 0.65 |
| 10 | 180 | 6.25 | 1.95 | 3 | 0.85 |
| 10 | 180 | 6.25 | 0.98 | 32/5 | 0.63 |

### Example 23

### Synergy of DMCU with methylene bisthiocyanate

Minimal inhibitory concentrations were determined for both dimethyl chlorourea and methylene bisthiocyanate (abbreviated MBT in Table 23) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with methylene bisthiocyanate from concentration ratios of DMCU to methylene bisthiocyanate from 1:40 to 50:1.

TABLE 23

| Used alone | | Used in Combination | | | |
|---|---|---|---|---|---|
| DMCU | | DMCU | | | |
| MIC | MBT MIC | MIC | MBT MIC | | Synergy |
| (QA) | (QB) | (Qa) | (Qb) | DMCU/MBT Ratio | Index |
| 10 | 8 | 0.10 | 8 | 1/80 | 1.01 |
| 10 | 8 | 0.10 | 4 | 1/40 | 0.51 |
| 10 | 8 | 0.20 | 4 | 1/20 | 0.52 |
| 10 | 8 | 0.10 | 2 | 1/20 | 0.26 |
| 10 | 8 | 0.78 | 4 | 1/5 | 0.58 |
| 10 | 8 | 6.25 | 2 | 3 | 0.88 |
| 10 | 8 | 6.25 | 1 | 6 | 0.75 |
| 10 | 8 | 6.25 | 0.5 | 25/2 | 0.69 |
| 10 | 8 | 6.25 | 0.25 | 25 | 0.66 |
| 10 | 8 | 6.25 | 0.125 | 50 | 0.64 |
| 10 | 8 | 10.00 | 0.125 | 80 | 1.27 |

### Example 24

### Synergy of DMCU with 2-bromo-2-nitropropane-1,3,-diol

Minimal inhibitory concentrations were determined for both dimethyl chlorourea and 2-bromo-2-nitropropane-1,3,-diol (abbreviated BNPD in Table 24) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 3 times and the results summarized below. Synergy indices were calculated according to the formula. The results indicate DMCU is broadly synergistic with 2-bromo-2-nitropropane-1,3,-diol from concentration ratios of DMCU to 2-bromo-2-nitropropane-1,3,-diol from 2:325 to 25:2.

TABLE 24

| Used alone | | Used in Combination | | | |
|---|---|---|---|---|---|
| DMCU | BNPD | DMCU | BNPD | | |
| MIC | MIC | MIC | MIC | DMCU/BNPD | Synergy |
| (QA) | (QB) | (Qa) | (Qb) | Ratio | Index |
| 10 | 24 | 0.10 | 32 | 1/325 | 1.34 |
| 10 | 24 | 0.10 | 16 | 2/325 | 0.68 |
| 10 | 24 | 0.10 | 8 | 1/80 | 0.34 |
| 10 | 24 | 0.20 | 4 | 1/20 | 0.19 |
| 10 | 24 | 1.56 | 8 | 1/5 | 0.49 |
| 10 | 24 | 6.25 | 8 | 5/4 | 0.96 |
| 10 | 24 | 1.56 | 2 | 5/4 | 0.24 |
| 10 | 24 | 6.25 | 4 | 3/2 | 0.79 |
| 10 | 24 | 6.25 | 1 | 6 | 0.67 |
| 10 | 24 | 6.25 | 0.5 | 25/2 | 0.65 |

### Example 25

### Synergy of DMCU with 2,2-dibromo-3-nitrilopropionamide

Minimal inhibitory concentrations were determined for both dimethyl chlorourea and 2,2-dibromo-3-nitrilopropionamide (abbreviated DBNPA in Table 25) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 5 times and the results summarized below. Synergy indices were calculated according to the formula. The results indicate DMCU is broadly synergistic with 2,2-dibromo-3-nitrilopropionamide from concentration ratios of DMCU to 2,2-dibromo-3-nitrilopropionamide from 1:125 to 100:1.

TABLE 25

| Used alone | | Used in Combination | | | |
|---|---|---|---|---|---|
| DMCU | | DMCU | | | |
| MIC | DBNPA | MIC | DBNPA | DMCU/DBNPA | Synergy |
| (QA) | MIC (QB) | (Qa) | MIC (Qb) | Ratio | Index |
| 10 | 11 | 0.10 | 16.00 | 1/160 | 1.46 |
| 10 | 11 | 0.06 | 8.00 | 1/125 | 0.73 |
| 10 | 11 | 0.10 | 8.00 | 1/80 | 0.74 |
| 10 | 11 | 0.20 | 8.00 | 1/40 | 0.75 |
| 10 | 11 | 1.00 | 4.00 | 1/4 | 0.46 |
| 10 | 11 | 3.13 | 8.00 | 2/5 | 1.04 |
| 10 | 11 | 2.00 | 4.00 | 1/2 | 0.56 |
| 10 | 11 | 3.13 | 4.00 | 4/5 | 0.68 |
| 10 | 11 | 3.13 | 2.00 | 3/2 | 0.49 |
| 10 | 11 | 4.00 | 2.00 | 2 | 0.58 |
| 10 | 11 | 6.25 | 2.00 | 3 | 0.81 |
| 10 | 11 | 4.00 | 1.00 | 4 | 0.49 |
| 10 | 11 | 6.25 | 1.00 | 6 | 0.72 |
| 10 | 11 | 4.00 | 0.50 | 8 | 0.45 |
| 10 | 11 | 6.25 | 0.50 | 12.5 | 0.67 |
| 10 | 11 | 4.00 | 0.25 | 16 | 0.42 |
| 10 | 11 | 6.25 | 0.25 | 25 | 0.65 |
| 10 | 11 | 4.00 | 0.13 | 32 | 0.41 |
| 10 | 11 | 6.25 | 0.13 | 50 | 0.64 |
| 10 | 11 | 4.00 | 0.06 | 64 | 0.41 |
| 10 | 11 | 6.25 | 0.06 | 100 | 0.63 |

### Example 26

### Synergy of DMCU with N-alkyl (C₁₂-C₁₆)-N,N-dimethyl benzylalkonium Chloride

Minimal inhibitory concentrations were determined for both dimethyl chlorourea and N-alkyl (C₁₂-C₁₆)-N,N-dimethyl benzylalkonium chloride (abbreviated QAC in Table 26) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 5 times and the results summarized below. Synergy indices were calculated according to the formula. The results indicate DMCU is broadly synergistic with N-alkyl (C₁₂-C₁₆)-N,N-dimethyl benzylalkonium chloride from concentration ratios of DMCU to N-alkyl (C₁₂-C₁₆)-N,N-dimethyl benzylalkonium chloride from 1:250 to 32:1.

TABLE 26

| Used alone | | Used in Combination | | | |
|---|---|---|---|---|---|
| DMCU | | DMCU | | | |
| MIC | QAC MIC | MIC | QAC MIC | | Synergy |
| (QA) | (QB) | (Qa) | (Qb) | DMCU/QAC Ratio | Index |
| 10 | 27 | 0.06 | 32 | 1/500 | 1.19 |
| 10 | 27 | 0.10 | 32 | 1/325 | 1.19 |
| 10 | 27 | 0.06 | 16 | 1/250 | 0.60 |
| 10 | 27 | 0.13 | 16 | 1/125 | 0.61 |
| 10 | 27 | 0.78 | 16 | 1/20 | 0.67 |
| 10 | 27 | 3.13 | 16 | 1/5 | 0.91 |
| 10 | 27 | 2.00 | 8 | 1/4 | 0.50 |
| 10 | 27 | 3.13 | 8 | 2/5 | 0.61 |
| 10 | 27 | 4.00 | 8 | 1/2 | 0.70 |
| 10 | 27 | 6.25 | 8 | 5/6 | 0.92 |
| 10 | 27 | 4.00 | 4 | 1 | 0.55 |
| 10 | 27 | 6.25 | 4 | 1.5 | 0.77 |
| 10 | 27 | 4.00 | 2 | 2 | 0.71 |
| 10 | 27 | 6.25 | 2 | 3 | 0.70 |
| 10 | 27 | 8.00 | 2 | 4 | 0.66 |
| 10 | 27 | 6.25 | 1 | 6 | 0.66 |
| 10 | 27 | 8.00 | 1 | 8 | 0.63 |
| 10 | 27 | 6.25 | 0.5 | 12.5 | 0.64 |
| 10 | 27 | 8.00 | 0.5 | 16 | 0.64 |
| 10 | 27 | 6.25 | 0.25 | 25 | 0.63 |
| 10 | 27 | 8.00 | 0.25 | 32 | 0.81 |

### Example 27

### Synergy of DMCU with the Combination biocide 2-methyl-5-chloro-isothiazolin-3-one/2-methyl-isothazolin-3-one

Minimal inhibitory concentrations were determined for both dimethyl chlorourea and the 2-methyl-5-chloro-isothiazolin-3-one/2-methyl-isothazolin-3-one combination biocide (abbreviated CMIT/MIT in Table 27) using the protocol described above with Escherichia coli as the test microbe. Using twice the concentration of the MIC expressed as parts per million as the highest concentration, checkerboard synergy plates were constructed as described, the wells inoculated to a final concentration of ˜5×10⁵ cfu/ml, incubated for 18-24 hours, and then scored visually for growth/no growth. The experiment was repeated 5 times and the results summarized below. Synergy indices were calculated according to the formula. The results indicate DMCU is broadly synergistic with the CMIT/MIT combination biocide from concentration ratios of DMCU to the CMIT/MIT combination biocide from 1:8 to 500:1.

TABLE 27

| Used alone | | Used in Combination | | | |
|---|---|---|---|---|---|
| DMCU | | DMCU | | DMCU/ | |
| MIC | CMIT/MIT | MIC | CMIT/MIT | (CMIT/MIT) | Synergy |
| (QA) | MIC (QB) | (Qa) | MIC (Qb) | Ratio | Index |
| 10 | 2 | 0.06 | 2 | 1/32 | 1.01 |
| 10 | 2 | 0.10 | 2 | 1/20 | 1.01 |
| 10 | 2 | 0.06 | 1 | 1/8 | 0.51 |
| 10 | 2 | 0.20 | 1 | 1/5 | 0.52 |
| 10 | 2 | 4 | 0.5 | 8 | 0.65 |
| 10 | 2 | 6.25 | 0.5 | 12 | 0.88 |
| 10 | 2 | 4 | 0.25 | 16 | 0.53 |
| 10 | 2 | 6.25 | 0.25 | 25 | 0.75 |
| 10 | 2 | 4 | 0.125 | 32 | 0.46 |
| 10 | 2 | 6.25 | 0.125 | 50 | 0.69 |
| 10 | 2 | 8 | 0.125 | 64 | 0.86 |
| 10 | 2 | 6.25 | 0.063 | 100 | 0.66 |
| 10 | 2 | 8 | 0.063 | 125 | 0.83 |
| 10 | 2 | 6.25 | 0.031 | 200 | 0.64 |
| 10 | 2 | 4 | 0.016 | 250 | 0.61 |
| 10 | 2 | 6.25 | 0.016 | 400 | 0.63 |
| 10 | 2 | 8 | 0.016 | 500 | 0.81 |
| 10 | 2 | 12.5 | 0.016 | 800 | 1.26 |

### Example 28

### Synergy of DMCU with Glutaraldehyde

Minimal inhibitory concentrations were determined for both dimethyl chlorourea and glutaraldehyde (abbreviated GLUT in the Table below) using the protocol described above with Escherichia coli as the test microbe. Using twice the concentration of the MIC expressed as parts per million, as the highest concentration, checkerboard synergy plates were constructed as described, the wells inoculated to a final concentration of ˜5×10⁵cfu/ml, incubated for 18-24 hours, and then scored visually for growth/no growth. The experiment was repeated 5 times and the results summarized below. Synergy indices were calculated according to the formula. The results indicate DMCU is broadly synergistic with glutaraldehyde from concentration ratios of DMCU to glutaraldehyde from 1:500 to 32:1.

TABLE 28

| Used alone | | Used in Combination | | | |
|---|---|---|---|---|---|
| DMCU | GLUT | DMCU | GLUT | | |
| MIC | MIC | MIC | MIC | DMCU/GLUT | Synergy |
| (QA) | (QB) | (Qa) | (Qb) | Ratio | Index |
| 10 | 45 | 0.063 | 32 | 1/500 | 0.72 |
| 10 | 45 | 0.098 | 32 | 1/325 | 0.72 |
| 10 | 45 | 0.098 | 16 | 2/325 | 0.37 |
| 10 | 45 | 0.125 | 16 | 1/125 | 0.55 |
| 10 | 45 | 4 | 16 | 1/4 | 0.76 |
| 10 | 45 | 6.25 | 16 | 2/5 | 0.98 |
| 10 | 45 | 4 | 8 | 1/2 | 0.58 |
| 10 | 45 | 6.25 | 8 | 4/5 | 0.80 |
| 10 | 45 | 4 | 4 | 1/1 | 0.49 |
| 10 | 45 | 8 | 4 | 2/1 | 0.67 |
| 10 | 45 | 12.5 | 4 | 3.125/1 | 0.89 |
| 10 | 45 | 8 | 2 | 4/1 | 0.63 |
| 10 | 45 | 12.5 | 2 | 6.25/1 | 0.86 |
| 10 | 45 | 8 | 1 | 8/1 | 0.82 |
| 10 | 45 | 6.25 | 0.5 | 12.5/1 | 0.64 |
| 10 | 45 | 8 | 0.5 | 16/1 | 0.61 |
| 10 | 45 | 6.25 | 0.25 | 25/1 | 0.63 |
| 10 | 45 | 8 | 0.25 | 32/1 | 0.81 |
| 10 | 45 | 12.5 | 0.25 | 50/1 | 1.26 |

1. A microbicidal composition comprising:
a first biocide and at least one second biocide
wherein the first biocide is selected from the group consisting of monochlorourea and modified monochlorourea; and
wherein the second biocide is selected from the group consisting of methyl monochlorourea, dimethyl monochlorourea, bromine activated monochloramine, monochloramine, hydrogen peroxide, 1-brorno-3-chloro-5,5-dimethylhydantoin, benzisothiazolone, 2-methylisothiazolone, tetrakis (hydroxymethyl) phosphonium sulfate, methylene bisthiocyanate, 2-bromo-2-nitropropane-1,3,-diol, 2,2-dibromo-3-nitrilopropionannide, N-alkyl (C₁₂-C₁₆)-N,N-dimethyl benzylalkonium chloride, the combination biocide 2-methyl-5-chloro-isothiazolin-3-one/2-methyl-isothazolin-3-one, and glutaraldehyde;
with the proviso that the first biocide is different from the second biocide.

2. The microbicidal composition of claim 1 wherein the first biocide is monochlorourea

3. The microbicidal composition of claim 1 wherein the first biocide is dimethyl monochlorourea.

4. The microbicidal composition of claim 1 wherein the ratio of the first biocide to the second biocide is from 1:100 to 800:1,

5. The microbicidal composition of claim 1 wherein the ratio of the first biocide to the second biocide is from 1: 20 to 200:1.

6. The microbicidal composition of claim 3 wherein the ratio of the first biocide to the second biocide is 1 :700 to 700:1

7. The microbicidal composition of claim 3 wherein the ratio of the first biocide to the second biocide is from 1:250 to 75:1.

8. A method of treating an aqueous system, the method comprising adding an effective amount of a first biocide and at least one second biocide to an aqueous system, wherein the first biocide is selected from the group consisting of monochlorourea and modified monochlorourea; and
wherein the second biocide is selected from the group consisting of methyl monochlorourea, dimethyl monochlorourea, bromine activated monochloramine, monochloramine, hydrogen peroxide, 1-bromo-3-chloro-5,5-dimethylhydantoin, benzisothiazolone, 2-methylisothiazolone, tetrakis (hydroxymethyl) phosphonium sulfate, methylene bisthiocyanate, 2-bromo-2-nitropropane-1,3,-diol, 2,2-dibromo-3-nitrilopropionamide, N-alkyl (C₁₂-C₁₆)-N,N-dimethyl benzylalkonium chloride, the combination biocide 2-methyl-5-chloro-isothiazolin-3-one/2-methyl-isothazolin-3-one, and glutaraldehyde;
with the proviso that the first biocide is different from the second biocide.

9. The method of claim 8 wherein the first biocide is monochlorourea

10. The method of claim 8 wherein the first biocide is dimethyl monochlorourea.

11. The method of claim 8 wherein the ratio of the first biocide to the second biocide is from 1:100 to 800:1,

12. The method of claim 8 wherein the ratio of the first biocide to the second biocide is from 1:20 to 200:1.

13. The method of claim 10 wherein the ratio of the first biocide to the second biocide is 1:700 to 700:1

14. The method of claim 10 wherein the ratio of the first biocide to the second biocide is from 1:250 to 75:1.

15. The method of claim 8 wherein the concentration of the first biocide is used in amounts of from 0.1 ppm to 100 ppm in the system being treated .

16. The method of claim 8 wherein the concentration of the at least one second microbiocide used is less than 150 ppm .

17. The method of claim 8 wherein the aqueous system is selected form the groups consisting of cooling water, boiler water, pulp and paper mill water wastewater.

18. The method of claim 8 wherein at least one second biocide is selected from the group consisting of bromine activated monochloramine and monochloramine.

19. The method of claim 8 wherein at least one second biocide is selected from the group consisting of 1-bromo-3-chloro-5,5-dimethylhydantoin, tetrakis (hydroxymethyl) phosphonium sulfate, 2-bromo-2-nitropropane-1,3,-diol, 2,2-dibromo-3-nitrilopropionamide and combination thereof.

20. The method of claim 8 wherein at least one second biocide is selected from the group consisting of the combination biocide 2-methyl-5-chloro-isothiazolin-3-one/2-methyl-isothazolin-3-one, and glutaraldehyde and combination thereof.
